(19) United States
(12) Patent Application Publication
(10) Pub. No.: US 2023/0319596 A1
(43) Pub. Date: Oct. 5, 2023

(54) RADAR DETECTION USING MOBILE NETWORK

(71) Applicant: Telefonaktiebolaget LM Ericsson (publ), Stockholm (SE)

(72) Inventors: Ali S. KHAYRALLAH, Mountain View, CA (US); Kumar BALACHANDRAN, Pleasanton, CA (US)

(21) Appl. No.: 18/023,738

(22) PCT Filed: Aug. 31, 2021
(86) PCT No.: PCT/IB2021/057968

§ 371 Date: Feb. 28, 2023

Related U.S. Application Data
(60) Provisional application No. 63/072,736, filed on Aug. 31, 2020.

(51) Int. Cl. H04W 24/02; G01S 7/02; H04W 16/14; H04B 17/309

(52) U.S. Cl. CPC H04W 24/02; G01S 7/023; G01S 7/021; H04W 16/14; H04B 17/309

(57) ABSTRACT

A method performed by a network node in a terrestrial network includes detecting, within a spectrum associated with the terrestrial network, a priority radar signal that is not a part of the terrestrial network. Based on detecting the priority radar signal, the network node performs at least one action to mitigate a mutual impact of the terrestrial network and the priority radar signal on each other.

### TECHNICAL FIELD

The present disclosure relates, in general, to wireless communications and, more particularly, systems and methods for radar detection using a mobile network.

### BACKGROUND

The scarcity of spectrum for mobile networks has led regulators to consider shared spectrum between a mobile network and an higher priority protected or primary incumbent service such as radar. The requirements are such that the mobile network needs to vacate spectrum in use by the incumbent service. The presence of the incumbent signal may be obtained through an external sensor network. This is the case with the Citizens Broadband Radio Service (CBRS) band in the US. It may also be detected directly by the receiver of a network node acting as a sensor. This is the case with WiFi in unlicensed spectrum when using dynamic frequency selection to detect the presence of radar.

Certain problems exist. For example, in the above cases, the incumbent service is typically present for a relatively long time and affects a relatively large area. There is new interest in sharing spectrum with airborne radar. This is the case with the 3 GHz band in the US. An airborne radar event may be short and its signal may affect a relatively small area of the network and only temporarily. Still the radar event needs to be detected quickly and accurately to enable the mobile network to react to the presence of the radar signal: 1) assess the impact of the interference to the mobile network and the effect of the network on radar receivers, 2) adjust the operation of the network to account for the degradation of performance, or 3) vacate the spectrum before it interferes with the radar receiver. This requires a different approach that boosts detection speed and reliability.

### SUMMARY

Certain aspects of the present disclosure and their embodiments may provide solutions to these or other challenges. For example, according to certain embodiments, methods and systems are provided that improve the detection speed and reliability by pooling resources across the mobile network.

According to certain embodiments, a method by a network node in a terrestrial network includes detecting, within a spectrum associated with the terrestrial network, a priority radar signal that is not a part of the terrestrial network. Based on detecting the priority radar signal, the network node performs at least one action to mitigate a mutual impact of the terrestrial network and the priority radar signal on each other.

According to certain embodiments, a network node includes processing circuitry configured to, or is otherwise adapted to, detect, within a spectrum associated with the terrestrial network, a priority radar signal that is not a part of the terrestrial network. Based on detecting the priority radar signal, the network node performs at least one action to mitigate a mutual impact of the terrestrial network and the priority radar signal on each other.

According to certain embodiments, a method by a wireless device in a terrestrial network includes obtaining information indicating a presence within a spectrum associated with the terrestrial network of at least one priority radar signal that is not a part of the terrestrial network. Based on the information indicating the presence of the at least one priority radar signal, the wireless device performs at least one action to mitigate a mutual impact of the terrestrial network and the at least one priority radar signal.

According to certain embodiments, a wireless device includes processing circuitry configured to, or is otherwise adapted to, obtain information indicating a presence within a spectrum associated with the terrestrial network of at least one priority radar signal that is not a part of the terrestrial network. Based on the information indicating the presence of the at least one priority radar signal, the wireless device performs at least one action to mitigate a mutual impact of the terrestrial network and the at least one priority radar signal.

Certain embodiments may provide one or more of the following technical advantages. For example, one technical advantage may be that certain embodiments enable the network to quickly and reliably detect the presence of a radar event, utilizing available network resources. As another example, a technical advantage may be that wireless devices such as terminal receivers may act as radar sensors and feed measurements back to the network as part of the radar detection process.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates a mainstream network layout, according to certain embodiments;

FIG. 2 illustrates an example scanning period for a network node, according to certain embodiments;

FIG. 3 an example site, according to certain embodiments

FIG. 4 illustrates an example wireless network, according to certain embodiments;

FIG. 5 illustrates an example network node, according to certain embodiments;

FIG. 6 illustrates an example wireless device, according to certain embodiments;

FIG. 7 illustrate an example user equipment, according to certain embodiments;

FIG. 8 illustrates a virtualization environment in which functions implemented by some embodiments may be virtualized, according to certain embodiments;

FIG. 9 illustrates an example method by a network node, according to certain embodiments;

FIG. 10 illustrates an example method by a wireless device, according to certain embodiments; and

FIG. 11 illustrates another example method by a wireless device, according to certain embodiments.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a User Equipment (UE) (directly or via another node) and/or with another network node. Examples of network nodes are NodeB, Master eNodeB (MeNB), a network node belonging to Master Cell Group (MCG) or Secondary Cell Group (SCG), base station (BS), multi-standard radio (MSR) radio node such as MSR BS, eNodeB (eNB), gNodeB (gNB), network controller, radio network controller (RNC), base station controller (BSC), relay, donor node controlling relay, base transceiver station (BTS), access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. Evolved-Serving Mobile Location Centre (E-SMLC)), Minimization of Drive Test (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, Personal Digital Assistant (PDA), Tablet, mobile terminals, smart phone, laptop embedded equipped (LEE), laptop mounted equipment (LME), Unified Serial Bus (USB) dongles, UE category M1, UE category M2, Proximity Services (ProSe) UE, Vehicle-to-Vehicle (V2V) UE, Vehicle-to-Anything (V2X) UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel And in the following the transmitter or receiver could be either gNB, or UE.

Certain embodiments include methods, systems, and techniques applicable to a Time Division Duplex (TDD) system, where the radar signal hits the frequency band during downlink slots. Certain embodiments may alternatively or additionally include methods, systems, and techniques applicable to a Frequency Division Duplex (FDD) system, where the radar signal hits the downlink frequency band or the uplink frequency band. The radar signal may operate as a blocker in spectrum adjacent to or near the physical channel that the mobile system is using. Alternatively, the radar signal may be operating in frequencies that either partially or completely overlap with a physical channel that the mobile system operates over.

One example of an incumbent service is airborne radar, which highlights the need for a detection approach with high speed and accuracy. However, in general one can consider other incumbent services that require a similar solution. For instance, an National Security and Public Safety (NSPS) network may be the incumbent service, in a certain spectrum, and may come online without warning in a relatively small area, and may move around as it handles an emergency. The mobile network sharing the same spectrum would benefit from a similar detection solution to that of airborne radar.

According to certain embodiments, methods and systems are provided in a network that take advantage of the base station receivers to capture the signal from many site locations and process the signal locally at each base station. Certain embodiments may also exploit the connectivity among base stations in the mobile networks and to the core network to further process jointly the outcomes of different receivers.

According to certain embodiments, methods and systems are provided in wireless devices such as terminal receivers and other UEs that take advantage of the wireless devices to capture the signal from many locations, process the signal locally at each wireless device, and feed information back from each wireless device to the network for further processing.

Certain embodiments may additionally or alternatively take advantage of the network's ability to create silent slots where neither base stations nor wireless devices transmit. Since the radar detection happens inside the network, certain embodiments may facilitate the decision to vacate the affected frequency band and the propagation of this decision to the nodes in the network.

Certain embodiments may apply to a TDD system, where network nodes have control over the allocation of uplink and downlink slots and network nodes, such as base stations, are used as sensors for radar detection. In such a TDD system, the network nodes may detect the radar signal during transmission slots dedicated to the uplink, according to certain embodiments. In some embodiments, the wireless devices may not be directly involved.

In certain embodiments, the wireless devices of the TDD system may listen for the radar signal as part of the radar detection process. In one example, the radar may operate during the downlink portion of the network node transmission. Thus, the radar signal may hit a downlink slot. In another example, the radar signal may hit a silent slot and the wireless devices may operate to detect the radar signal.

In still other embodiments, both the network nodes and the wireless devices of the TDD system may work together to detect the radar signal. For example, because the inference of the presence of radar by network nodes by observing the pattern of high interference from the variations in throughput may be challenging, both the wireless devices and the network nodes may listen for and detect radar signals.

According to certain embodiments, the methods, techniques, and systems disclosed herein may also apply to a FDD system where the radar signal hits the downlink frequency band, and wireless devices listen for the radar signal as part of the radar detection process.

In other embodiments, the methods apply to an FDD system where the radar signal hits the uplink band, and the network nodes may listen for and detect radar signals.

### Network Layout

A TDD system is described first. Differences specific to an FDD system are noted below.

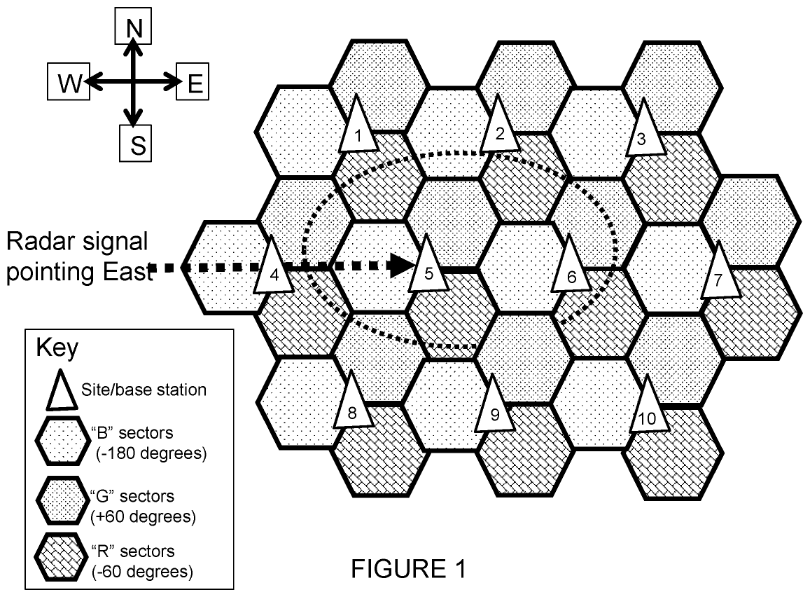

FIG. 1 illustrates a mainstream network layout, according to certain embodiments. In the depicted example embodiment, each site has 3 sectors (or cells). Referring to FIG. 1, a first group of “B” sectors include antennas pointing at −180 degrees (or West). A second group of “G” sectors include antennas pointing at +60 degrees. A third group of “R” sectors include antennas pointing at −60 degrees. It may be assumed that the transmit and receive antenna patterns are fixed and the same, in certain embodiments. However, the effect of active beam forming will be considered in certain embodiments. Herein, cells may be referred to by the site number and sector. Thus, the “G” sector of site 1 is referred to as G1.

It may be assumed that frequency reuse is 1 by default. A more conservative reuse could also be considered, for instance ⅓, where cells of the same color occupy the same one third of the system bandwidth.

### Radar Event

A radar signal may be expected to be highly directional. The extent of the area it illuminates on the ground depends on distance and incident angle, but here we assume that multiple cells are directly hit. Without much loss of generality, suppose the airborne radar signal is pointing East, and illuminating a number of cells around site 5, as shown in FIG. 1 with a dashed contour.

Here we consider a TDD system where the radar signal may hit during uplink, downlink or silent slots. Then the receivers most affected by the radar signal are B5 and B6. Depending on sidelobes in the cell beam pattern and radar signal reflections, other cells such as cells G5, R5, G6, R6, R1 etc. will be affected to a lesser extent.

Most wireless devices, which may also be referred to as terminals or terminal receivers, in B5, G5, R5, and B6 are likely to be affected by the radar signal. Some wireless devices in adjacent cells, such as R1 an G8 will also be affected. Of course, individual wireless devices will be affected differently depending on how their intended signal and the radar signal are attenuated at the wireless device location. But any wireless device can contribute as a sensor in the radar detection process.

Keep in mind that it is desirable to detect the radar event early, when the signal is relatively weak. So the above-identified cells give is the best opportunity for early detection. As the airborne radar gets closer, its signal may overwhelm the mobile network signals in a wide area covering many cells. This is usually detectable first in a benign manner in the way the Automatic Gain Control (AGC) in the network node receiver activates, potentially desensitizing the receiver and eventually reaching a saturation level that prevents the AGC from creating a signal that is within the dynamic range of the Analog-to-Digital Converter (ADC), where the receiver is unable to discriminate the desired signal in the presence of the radar signal.

In the sort of radar signal of interest, the aggressor waveform is pulsed. As an example, the radar pulses may have a duty cycle of 1-2 kHz. Moreover, the pulse may occupy a small fraction (e.g., 5%) of the pulse period, leaving the remaining portion (viz. 95%) silent, so that the radar receiver can detect the return signal as it traverses the distance between the radar transmitter to the target and back. In the case of airborne radar signals, such as those used by an Airborne Warning and Control System (AWACS), the radar pulses may be sequentially transmitted at different azimuthal angles across the entire 360° around the aircraft over a scanning period (e.g., 10 s). This further implies that the cells that are affected on the network will not be subject to harmful interference for a prolonged period of time. Harmful interference is defined as interference that will prevent use of the cellular network for digital communication. Thus, such a signal may be amenable to detection for a few pulse periods in the entirety of the scanning period. While this generalization offers a certain flexibility, choice of various parameters can represent a variety of aggressor waveforms. It must also be noted that expected periodicities in the radar signature may be subject to variations, e.g. when the aircraft banks or changes direction of motion in the process of station-keeping.

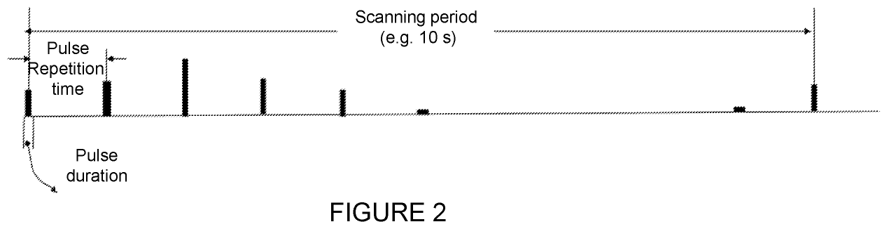

FIG. 2 illustrates an example scanning period for a network node, according to certain embodiments. In the example, the airborne radar has a 360 degree span over 10 seconds and is pointed towards a plurality of base station antennas over a part of that scan period. The pulses themselves may be 1 microsecond in width and the pulse repetition may be every 0.5 s, in a particular embodiment. As illustrated in FIG. 2, the pulse energy over a single scanning period as received by a base station in the network and the energy varies as the boresight of the radar antenna moves across the receive boresight of the base station antenna before moving out of view. However, FIG. 2 is only an example and is not meant to reflect every such situation. It is recognized that the scanning period my vary.

### Received Sample Processing

A multi-level structure is considered. According to certain embodiments, the individual wireless device (i.e., terminal receivers) process the samples and produce local measurements for each cell during the downlink reception periods. These measurements are conveyed to the serving network node from wireless devices across the cell.

According to certain embodiments, the individual network node (i.e., base station) may process the measurements received from wireless devices and produce local measurements for each cell. This may be referred to as upstream processing.

According to certain embodiments, the individual network node (i.e., base station) receivers may process their own received samples and produce local measurements for each cell. This may also be referred to as upstream processing.

Those measurements may be further processed jointly across multiple network nodes. This stage may also be referred to as upstream processing, which occurs in a node receiving information from multiple cells. Thus, the output from individual cells can be jointly processed across multiple cells, within a network node and/or across network nodes. Upstream processing may occur in a base station, the core network, or an intermediate node.

Below, receiver sample processing by the wireless devices and/or network nodes are discussed in more detail below. According to certain embodiments, samples may be processed one slot at a time. If the slot is unoccupied by an uplink or downlink signal, it may be called a measurement slot. The cases of an uplink slot or a downlink slot are addressed later.

Wireless Device Antenna Directivity

Wireless devices (i.e., terminal receivers) may have multiple receive antennas. For instance, a handheld may have two small phased arrays, pointing to the front and the back. When using the wireless device as a radar signal sensor, we may take advantage of the high directivity of the radar signal and the availability of these multiple receive antennas. For example, the front and back signals may be processed separately, and reported separately by the wireless device, or they may be processed jointly in the wireless device to capture the best signal combination etc. Standards such as 5G NR support beamforming and MIMO capabilities in wireless devices that can be used to direct the radiation pattern away from the radar signal, thus desensitizing the gain in the direction of a radar signal in a way that brings the radar signal within the receiver dynamic range.

Measurement Slot

From the perspective of a network node, in a measurement slot, it may be assumed that the network node (i.e., base station) is silent, and so are the wireless devices (i.e., terminals) attached to the cell served by the network node. This may, for example, be achieved in the network by the mere act of not scheduling any terminals for uplink transmission.

From the perspective of the wireless device, a measurement slot may include a slot when only the base station is silent. Wireless devices may then listen for a radar signal. This may, for example, be achieved in the network by the mere act of not scheduling any wireless devices to receive downlink transmission.

By default, it may also be assumed that all network nodes in the network are coordinated to have the same measurement slot. If the network nodes do not coordinate their measurement slots, then in the measurement slot of the network node of interest, the signals from other cells will simply appear as a higher noise level and make it harder to detect the radar signal.

According to certain embodiments, normal uplink transmission is scheduled, and the dynamic variations of average signal levels from an expected mean level, as received by a network node, may be used to classify the presence of interference that is not of from users in the mobile network. In this mode, one or more slots from the uplink portion of the TDD signal is used as a measurement slot by the network node. A degradation of C/I in cadence with the expected signature of the radar pulses may be used as a metric in addition to other characteristics of positive detection, such as discrimination of the spectral occupancy of the radar waveform against the normal uplink behavior in the mobile system.

Saturation events in the network node receiver or statistically significant variations of the AGC control voltage may additionally be used as indicators of radar presence.

Radar Signature

At each network node and/or wireless device, the received samples may be processed differently depending on the available side information about the incumbent signal. For instance, a radar signal has a signature. If that signature is known at the receiver, then the receiver can perform a correlation with the radar signature.

The correlation computation may be shifted in time or in frequency to try to capture the radar signal at different spots. As used herein, the measurement number k is denoted, corresponding to time shift T(k) and frequency shift F(k), as M(k). Suppose there are K measurements in the slot, then all K values are stored for further upstream joint processing across cells.

The correlation of the radar signature may be performed with all the expected modes of the radar waveform. For example, the pulsed radar system similar to that used by the AWACS radar would expose a signature that correlated with the duration of the pulse, the on-off period of the pulse and the expected number of pulses detectable before the directionality of the radar aperture causes the pulsed waveform to disappear over the scanning period.

According to certain embodiments, the act of correlation may be implicitly performed within a Machine Learning model that also includes other phenomena such as the variation in throughput and geometry as reported or detected at the network node and/or wireless device.

Radar Limited Characteristics

According to certain embodiments, the receiver (network node and/or wireless device) may only know certain characteristics of the incumbent signal. For instance, it may know the bandwidth occupancy and the time occupancy of the radar signal. Then the receiver can compute the energy within a bandwidth window and a time window. As in the above case, the energy computation may be shifted in time and frequency. The values may be stored for further upstream processing.

No Radar Characteristics

According to certain embodiments, which may be considered a degenerate case, the receiver (network node and/or wireless device) may not know any of the radar signal characteristics and may suffer interference from a radar with unclassified signature information. Then it may compute the energy across the time slot and across the total bandwidth of the baseband signal and produce a single measurement for the slot.

### Network Node Processing

Network Node Processing in an Uplink Slot

In this example scenario, the wireless devices in the cell are transmitting signals so the network node receiver tries to detect the radar signal in addition to its normal role in receiving its uplink signals.

In a first approach, the network node receiver may process the uplink signals from its own cells as usual. Then, the network node may reconstruct their corresponding signals and subtract them form the original received signal. As a result, ideally the residual signal after subtraction will be free of the received signals from the wireless device. In practice, the effect of those signals will be reduced. Now, the residual signal can be processed as in the measurement slot case, described above.

The mechanism for signal reconstruction and subtraction is well known from interference cancellation. The difference is that here it is used to help detect the radar signal from the residual signal.

In a second approach, the quality of the signal received from the wireless device is used as an indirect indication of the presence of a radar signal. For example, the number of estimated block errors can be used as an indicator. Another example is the signal to noise ratio estimate, which can be a byproduct of the channel estimation process and can be used as an indicator.

The outcome of the first or second approach, or both, are stored for further upstream processing by a network node or a core network node.

Network Node Processing in a Downlink Slot

In a typical network node such as a base station, the base station receiver will be jammed by its own transmit signal during a downlink slot. In this case, the base station receiver will be ineffective at detecting the radar signal.

Full Duplex

If the network node is protected from its transmitter and is capable of so called “full duplex”, then the network node may be used for radar detection as described earlier for a measurement slot.

To achieve full duplex capability typically requires a combination of techniques, such as cancellation of the transmit signal in RF and further cancellation of the residual transmit signal in baseband. This is further facilitated by having separate transmit and receive antennas, which can placed judiciously to reduce self-jamming.

Upstream Processing from the Perspective of the Network Node

The upstream processing stage takes advantage of knowledge about the network layout. The geographical location of the sites as well as the beam directions of the cells should be factored into the upstream processing.

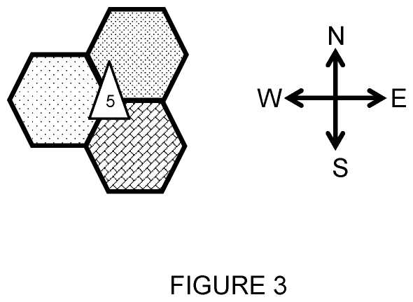

Referring back to the example in FIG. 1, the radar signal may be expected to have a strong local presence and a strong directional presence. Referring to FIG. 1, consider site 5, for example. The measurements from local blue cells together in the neighbor set of B5 may be processed as follows: {B4, B5, B6, B1, B2, B9, B9}. FIG. 3 also represents site 5, according to certain embodiments.

More generally, the neighbor set may be chosen by the network node to be compact geographically, and may include cells further away. The size of the neighbor set should be by guided by the size of the radar beam spot at a distance where the radar signal is detectable.

For example, consider the above example where there are K cell measurements M(k) at time shift T(k) and frequency shift F(k). For simplicity, the network node may assume that T(k) and F(k) are the same across cells, and the notation may be extended to write explicitly M(k,B4) to indicate cell B4. The same notation may be used for other cells. For instance, the network node may accumulate measurements across the set as:

F1(k,B5)=M(k,B4)+ . . . +M(k,B9)

More generally, the network node may choose F1 to be a function f( ) of measurements across the set:

F1(k,B5)=f(M(k,B4), . . . ,M(k,B9))

For instance, the function f( ) may be a linear combination, an order statistic function such as the median or another percentile, or an 1-L filter (which combines the characteristics of linear and order statistics operators).

According to certain embodiments, the network node may further process the outcomes F1(k,) across the index k, representing the pair (T(k), F(k)). Recall that the rationale for the time and frequency shifted measurement windows is to try to match the presence of the radar signal. So the network node may expect that a well matched window will produce a high value for F1(k,) whereas mismatched windows will produce small values for F1(k,). Thus, the network node may compute the maximum as:

F2(B5)=max(F1(k,B5), . . . ,F1((k,B9))

More generally, according to certain embodiments, the network node may choose F2 to be a function g( ) of measurements across the indices k:

F2(B5)=g(F1(k,B4), . . . ,M(k,B9))

For instance, the function g( ) may be an order statistic function such as a high percentile, e.g. 90 percentile.

According to certain embodiments, the network node may apply the same process to other neighborhoods, and those neighborhoods may be non-overlapping or overlapping.

Finally, the network node may process the signal across neighborhoods, in some embodiments. Again, the network node may expect F2( ) to be high when the neighborhood matches the radar beam spot, and low otherwise. Thus, the network node may compute the maximum across neighborhoods as:

F3(B)=max(F2(B5), . . . )

More generally, the network node may choose F2 to be a function h( ) of measurements across neighborhoods as:

F3(B)=h(F2(B5), . . . )

For instance, the function h( ) may be an order statistic function such as a high percentile, e.g. 90 percentile.

According to certain embodiments, the network node may process the green cells or the red cells in a similar way as the blue cells, to obtain F3(G) and F3(R).

Finally, the network node may make a decision on whether a radar signal is present based on F3(B), F3(G) and F3(R). For instance, the network node may compute the maximum value:

F4=max(F3(B),F3(G),F3(R))

And compare F4 to a baseline value. If the decision is that a radar signal is present, then the network node may also make more granular estimates, including which color is affected, which neighborhood, and which index.

The above computations are provided as one example of network node processing. It is recognized that the network node may choose another order of upstream processing, as long as geographic and directional properties of the network are respected. For instance, the network node may process across indices k for the same cell first. Then process across the neighbor set second. The network node may also process across colors (cells) of the same site in an early stage of upstream processing.

Active Beamforming

If the network node is capable of active beamforming, then this capability may be exploited in the radar detection process. For instance, if the beam can be moved vertically, then it is beneficial to tilt it more upward than normal in order to better capture the radar signal coming down from a plane.

If the beam can be moved horizontally, then it may be beneficial to sweep the beam and try to adjust the angle to follow the rough direction of the airplane over time

### Wireless Device Processing

As noted above, the network node is silent during a measurement slot. As discussed above, the network node receivers are used to listen to the radar signal during this slot. Below, both network node receivers and wireless device receivers are considered as part of the same sensor network. Their outcome can be aggregated during upstream processing.

Wireless Device Processing in a Downlink Slot

According to certain embodiments, the network node that is serving the cell is transmitting on the downlink slot, so the wireless device tries to detect the radar signal in addition to its normal role in receiving its intended downlink signal.

In a first approach, the wireless device will process the downlink signal from its own serving network node as usual. Then, the wireless device will reconstruct their corresponding signals and subtract them form the original received signal. As a result, ideally the residual signal after subtraction will be free of the received signal from the network node. In practice, the effect of that signal will be reduced. Now, the residual signal can be processed as in the measurement slot case, described above.

The mechanism for signal reconstruction and subtraction is well known from interference cancellation. The difference is that here it is used to help detect the radar signal from the residual signal.

In the event that a wireless device senses extraordinary interference during a downlink slot, and is programmed with a facility that autonomously causes that mobile to map periodic interference, an interference report could be generated by the wireless device for transmission on an uplink slot and at a time when the pulsed radar does not affect the ability of the wireless device to be scheduled for a channel quality measurement to be returned to the base station. The 5G NR system allows for RSRP and RSRQ measurements by wireless devices to be returned to the base station.

According to certain embodiments, the wireless device would return RSRP measurements on a series of downlink slots in a programmed sequence and the network node would attempt to aggregate from different wireless devices to validate or verify possible radar presence by observation of spikes in interference by degradation of the RSRP and RSRQ.

In a second approach, the quality of the signal received by the wireless device is used as an indirect indication of the presence of a radar signal. For example, the number of estimated block errors can be used as an indicator. Another example is the signal to noise ratio estimate, which can be a byproduct of the channel estimation process, can be used as an indicator.

According to a particular embodiment, the dynamic variations of average received signal levels from an expected mean level may be used to classify the presence of interference that is not from network nodes in the mobile network. In this mode, the entire downlink portion of the TDD signal is used as a measurement slot. A degradation of C/I in cadence with the expected signature of the radar pulses may be used as a metric in addition to other characteristics of positive detection, such as discrimination of the spectral occupancy of the radar waveform against the normal uplink behavior in the mobile system. The raw data from such measurements may in turn be used within a machine learning system that is modeled to detect the probability of radar presence. An inference determining radar presence would be predicated on the probability measure exceeding a threshold.

According to certain embodiments, saturation events in the wireless device receiver or statistically significant variations of the AGC control voltage may additionally be used as indicators of radar presence. Such events can be translated into a maximum quality degradation as recorded by the RSRP or RSRQ measurements that are normally returned to the network as part of standardized 3GPP measurement procedures.

According to certain embodiments, the outcome of the first approach with network node signal cancellation, or second approach without, or both, are then transmitted to the serving network node on the uplink for further upstream processing.

Wireless Device Processing in an Uplink Slot

In a typical wireless device, the receiver will be jammed by its own transmit signal during an uplink slot. In this case, the wireless device will be ineffective at detecting the radar signal.

Upstream Processing from the Perspective of the Wireless Device

The upstream processing stage takes advantage of knowledge about the network layout. The geographical location of the sites and cells should be factored into the upstream processing.

Referring back to the example in FIG. 1, the radar signal is expected to have a strong local presence. As an example, site 5 may be again considered. Measurements from the following cells may be jointly processed, according to certain embodiments:

{B5,G5,R5}

More generally, the wireless device may chose a neighbor set to be compact geographically, and may include cells further away. The size of the neighbor set should be by guided by the size of the expected radar beam spot at a distance where the radar signal is detectable. For instance, the closest neighboring cells of site 5 may be chosen:

{B5,G5,R5,R1,B6,G8}

The example may be described with that example set. Recall that, in the example scenario, there are K cell measurements M(k) at time shift T(k) and frequency shift F(k). For simplicity, it may be assumed that T(k) and F(k) are the same across cells, and the notation may be extended to write explicitly M(k,B4) to indicate cell B4. The same notation may be used for other cells. For instance, the wireless device may accumulate measurements across the set:

F1(k,5)=M(k,B5)+ . . . +M(k,G8)

More generally, the wireless device may choose F1 to be a function f( ) of measurements across the set

F1(k,5)=f(M(k,B5), . . . ,M(k,G8))

For instance, the function f( ) may be a linear combination, an order statistic function such as the median or another percentile, or an 1-L filter (which combines the characteristics of linear and order statistics operators).

The wireless device may further process the outcomes F1(k,) across the index k, say over the range {1, . . . , K} representing the pair (T(k), F(k)). Recall that the rationale for the time and frequency shifted measurement windows is to try to match the presence of the radar signal. So, the wireless device may expect that a well matched window will produce a high value for F1(k,) whereas mismatched windows will produce small values for F1(k,). Thus, the wireless device may choose to compute the maximum as:

F2(5)=max(F1(1,5), . . . ,F1(K,5))

More generally, the wireless device may choose F2 to be a function g( ) of measurements across the indices k

F2(5)=g(F1(1,5), . . . ,F1(K,5))

For instance, the function g( ) may be an order statistic function such as a high percentile, e.g. 90 percentile.

The same process can be applied to other sites, each with its own neighborhood, and those neighborhoods may be non-overlapping or overlapping for different sites.

Furthermore, the output of different sites may be considered, each with its own neighboring cell set, and then combine them for a final decision

F3=max(F2(1),F2(2), . . . ,F2(5) . . . )

More generally, according to certain embodiments, the wireless device may choose F2 to be a function h( ) of measurements across neighborhoods:

F3=h(F2(1),F2(2), . . . ,F2(5) . . . )

For instance, the function g( ) may be an order statistic function such as a high percentile, e.g. 90 percentile.

Then F3 may be compared to a threshold for a decision on radar presence.

If the decision is that a radar signal is present, then the wireless device may also make more granular estimates, including which color is affected, which neighborhood, and which index.

Again, the above computations are provided as one example of network node processing. It is recognized that another order of upstream processing may be used with somewhat similar outcome, as long as the geographic properties of the network are respected. For instance, the wireless device may process across indices k for the same cell first. Then process across the neighbor set second.

### FDD System

All of the above described techniques and embodiments also apply to the FDD scenario, with the exception of the combination of terminals measurements and network node measurements.

Radar in Downlink Frequency Band

First consider the case where the radar signal hits the downlink frequency band, and the wireless devices listen for the radar signal in that band. Downlink slots are handled in the same way as in TDD. Also downlink measurement slots can be defined where the base station does not transmit over the downlink frequency band. Measurements are reported to the serving network node in the uplink band, and upstream processing in the network node and beyond is handled as in TDD. Note that base station receivers are not normally capable of listening to the downlink band, so they are not used for measurements.

Radar in Uplink Frequency Band

Next consider the case where the radar signal hits the uplink frequency band, and the base stations listen for the radar signal in that band. Uplink slots are handled in the same way as in TDD. Also, uplink measurement slots can be defined where terminals do not transmit in the uplink frequency band. Received samples are processed at the serving network node, and upstream processing in the network node and beyond is handled as in TDD. Note that terminal receivers are not normally capable of listening to the uplink band, so they are not used for measurements.

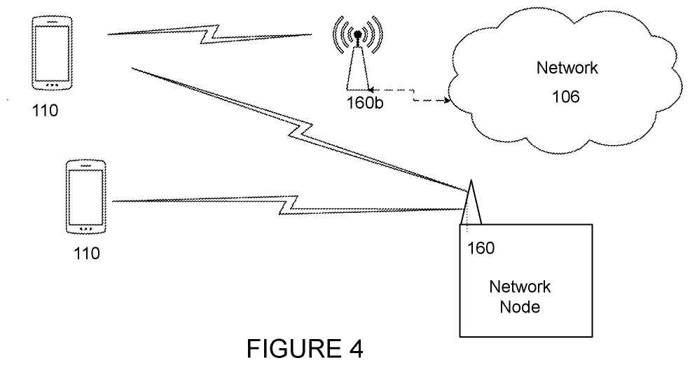

FIG. 4 illustrates a wireless network, in accordance with some embodiments. Although the subject matter described herein may be implemented in any appropriate type of system using any suitable components, the embodiments disclosed herein are described in relation to a wireless network, such as the example wireless network illustrated in FIG. 4. For simplicity, the wireless network of FIG. 4 only depicts network 106, network nodes 160 and 160b, and wireless devices 110. In practice, a wireless network may further include any additional elements suitable to support communication between wireless devices or between a wireless device and another communication device, such as a landline telephone, a service provider, or any other network node or end device. Of the illustrated components, network node 160 and wireless device 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and wireless device 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

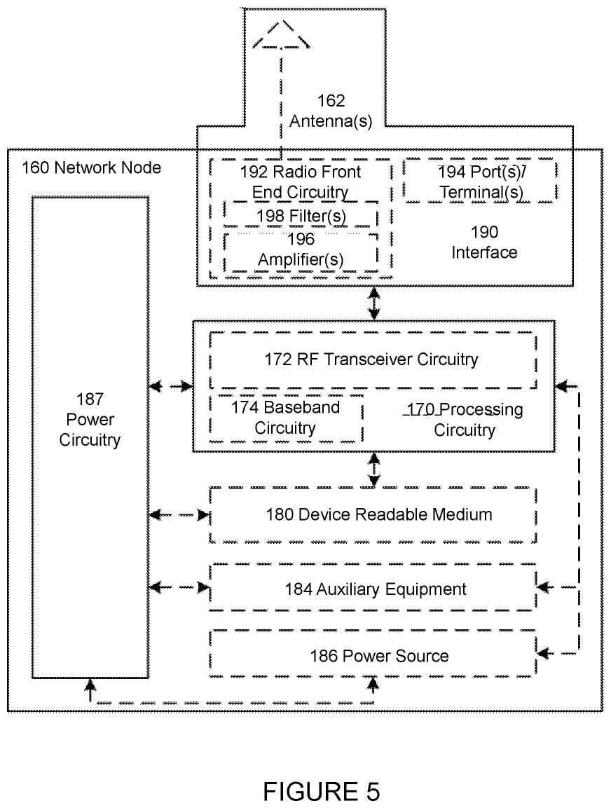

FIG. 5 illustrates an example network node 160, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 5, network node 160 includes processing circuitry 170, device readable medium 180, interface 190, auxiliary equipment 184, power source 186, power circuitry 187, and antenna 162. Although network node 160 illustrated in the example wireless network of FIG. 5 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, Global System for Mobile Communications (GSM), Wideband Code Division Multiplexing Access (WCDMA), Long Term Evolution (LTE), New Radio (NR), WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units.

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or wireless devices 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or wireless devices via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 5 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

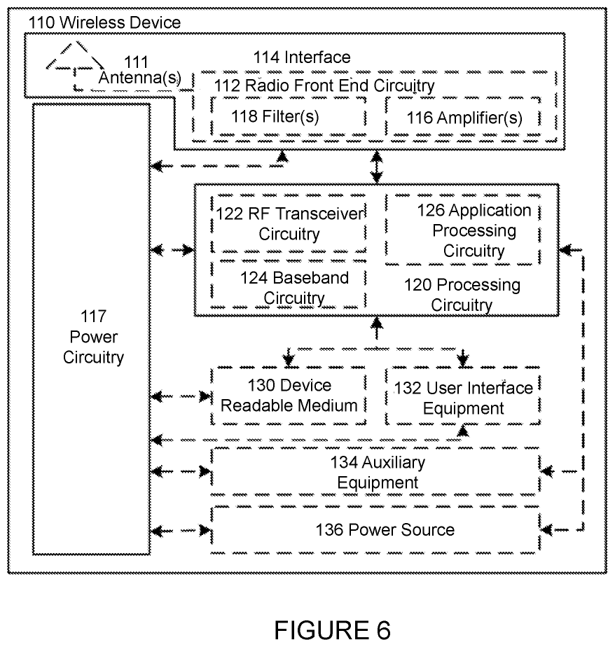

FIG. 6 illustrates an example wireless device 110. According to certain embodiments. As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. Wireless device 110 may include multiple sets of one or more of the illustrated components for different wireless technologies supported by wireless device 110, such as, for example, Global System for Mobile Communications (GSM), Wideband Code Division Multiplexing Access (WCDMA), Long Term Evolution (LTE), New Radio (NR), WiFi, WiMAX, or Bluetooth wireless technologies, just to mention a few. These wireless technologies may be integrated into the same or different chips or set of chips as other components within wireless device 110.

Antenna 111 may include one or more antennas or antenna arrays, configured to send and/or receive wireless signals, and is connected to interface 114. In certain alternative embodiments, antenna 111 may be separate from wireless device 110 and be connectable to wireless device 110 through an interface or port. Antenna 111, interface 114, and/or processing circuitry 120 may be configured to perform any receiving or transmitting operations described herein as being performed by a wireless device. Any information, data and/or signals may be received from a network node and/or another wireless device. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, wireless device 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or wireless devices via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device 110 components, such as device readable medium 130, wireless device 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of wireless device 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a wireless device may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of wireless device 110, but are enjoyed by wireless device 110 as a whole, and/or by end users and the wireless network generally.

Processing circuitry 120 may be configured to perform any determining, calculating, or similar operations (e.g., certain obtaining operations) described herein as being performed by a wireless device. These operations, as performed by processing circuitry 120, may include processing information obtained by processing circuitry 120 by, for example, converting the obtained information into other information, comparing the obtained information or converted information to information stored by wireless device 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with wireless device 110. Such interaction may be of many forms, such as visual, audial, tactile, etc. User interface equipment 132 may be operable to produce output to the user and to allow the user to provide input to wireless device 110. The type of interaction may vary depending on the type of user interface equipment 132 installed in wireless device 110. For example, if wireless device 110 is a smart phone, the interaction may be via a touch screen; if wireless device 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into wireless device 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from wireless device 110, and to allow processing circuitry 120 to output information from wireless device 110. User interface equipment 132 may include, for example, a speaker, a display, vibrating circuitry, a USB port, a headphone interface, or other output circuitry. Using one or more input and output interfaces, devices, and circuits, of user interface equipment 132, wireless device 110 may communicate with end users and/or the wireless network and allow them to benefit from the functionality described herein.

Auxiliary equipment 134 is operable to provide more specific functionality which may not be generally performed by wireless devices. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used, wireless device 110 may further comprise power circuitry 137 for delivering power from power source 136 to the various parts of wireless device 110 which need power from power source 136 to carry out any functionality described or indicated herein. Power circuitry 137 may in certain embodiments comprise power management circuitry. Power circuitry 137 may additionally or alternatively be operable to receive power from an external power source; in which case wireless device 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of wireless device 110 to which power is supplied.

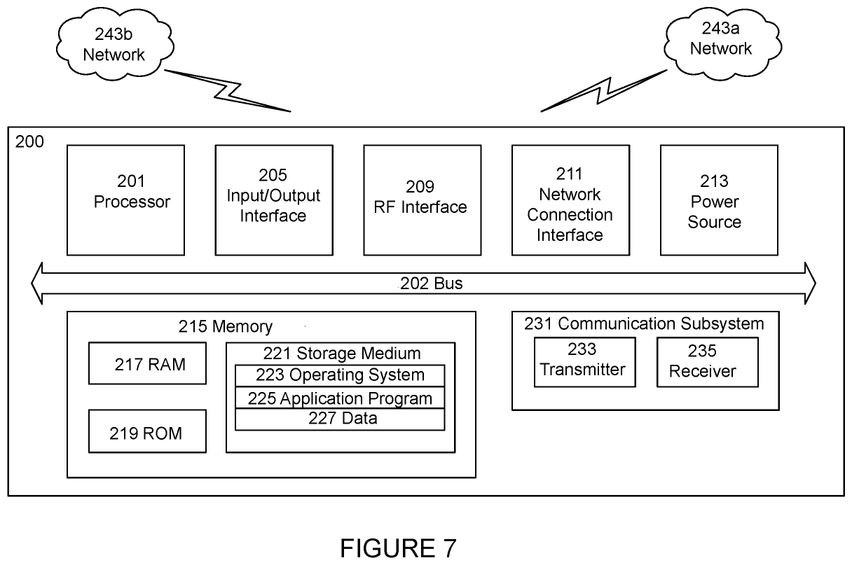

FIG. 7 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 5, is one example of a wireless device configured for communication in accordance with one or more communication standards promulgated by the 3^{rd} Generation Partnership Project (3GPP), such as 3GPP's GSM, UMTS, LTE, and/or 5G standards. As mentioned previously, the term wireless device and UE may be used interchangeable. Accordingly, although FIG. 7 is a UE, the components discussed herein are equally applicable to a wireless device, and vice-versa.

In FIG. 7, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 7, or only a subset of the components. The level of integration between the components may vary from one UE to another UE. Further, certain UEs may contain multiple instances of a component, such as multiple processors, memories, transceivers, transmitters, receivers, etc.

In FIG. 7, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 7, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 7, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another wireless device, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

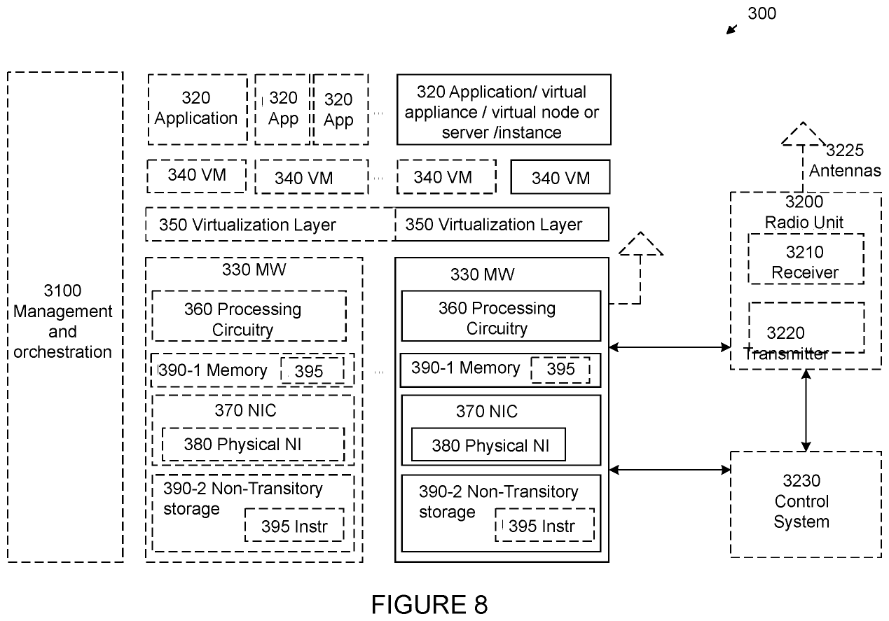

FIG. 8 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 8, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 8.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be affected with the use of control system 3230 which may alternatively be used for communication between the hardware nodes 330 and radio units 3200.

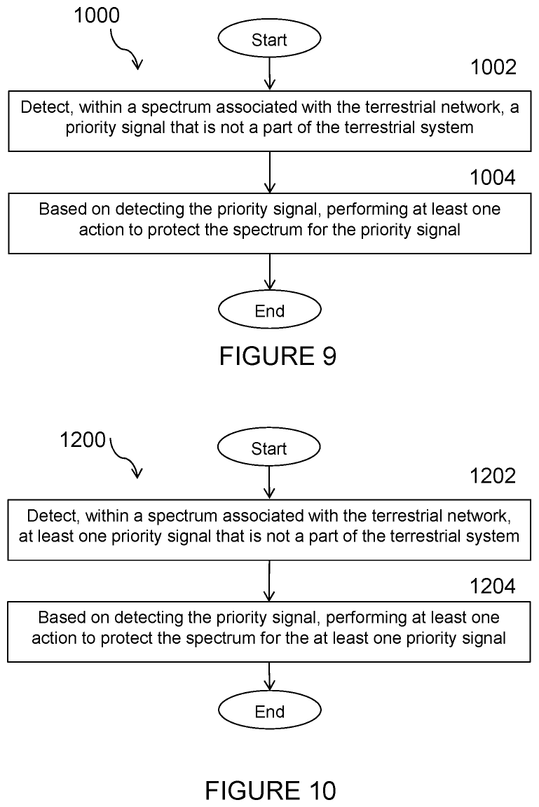

FIG. 9 depicts a method 1000 by a network node 160 in a terrestrial network, according to certain embodiments. At step 1002, the network node 160 detects, within a spectrum associated with the terrestrial network, a priority radar signal that is not a part of the terrestrial network. Based on detecting the priority radar signal, the network node 160 performs at least one action to mitigate a mutual impact of the terrestrial network and the priority radar signal on each other, at step 1004.

In a particular embodiment, when detecting the priority radar signal that is not a part of the terrestrial network, the network node 160 performs at least one of: receiving, from a wireless device, information indicating a presence of the priority radar signal; and receiving, from another network node, information indicating the presence of the priority radar signal.

In a particular embodiment, the information comprises at least one of: a level of interference; at least one RSRP measurement; and at least one RSRQ measurement.

In a particular embodiment, when detecting the priority radar signal that is not a part of the terrestrial network, the network node 160 performs at least one of: determining that an uplink transmission from at least one wireless device 110 varies from an average or expected uplink transmission; and determining that a block error rate associated with an uplink transmission from at least one wireless device 110 varies from an expected block error rate.

In a particular embodiment, when detecting the priority radar signal that is not part of the terrestrial network, the network node 160 compares and/or correlates the priority radar signal to a radar signature identifying at least one of an expected bandwidth occupancy and time occupancy of the spectrum by the priority radar signal.

In a particular embodiment, when performing the at least one action, the network node 160 performs at least one of: vacating the spectrum by the network node 160; transmitting, to at least one other network node 160, a signal to trigger the at least one other network node to abstain from transmitting in the spectrum; and transmitting, to at least one wireless device 110, a signal to trigger the at least one wireless device to abstain from transmitting in the spectrum.

In a particular embodiment, when detecting the priority radar signal, the network node 160 performs at least one measurement in at least one time period or across at least a portion of a bandwidth of the spectrum to determine a presence of the priority radar signal within the spectrum.

In a particular embodiment, when detecting the priority radar signal, the network node 160 selects at least one or at least a portion of a neighboring cell within the terrestrial network and performs the at least one measurement with respect to the at least one neighboring cell or the portion of the neighboring cell.

In a further particular embodiment, the at least one neighboring cell comprises a plurality of sets of neighboring cells, and each set of neighboring cells is associated with a specific sector of a deployed cell site, and each specific sector is oriented in approximately a same azimuth relative to a reference compass direction.

In a further particular embodiment, no devices are scheduled to transmit during the at least one time period.

In a particular embodiment, the network node is capable of full duplex and the priority radar signal is detected while the network node is simultaneously transmitting at least one signal.

In a particular embodiment, when detecting the priority radar signal, the network node 160 computes an energy level associated with the priority radar signal within the spectrum.

In a particular embodiment, the network node comprises a base station.

In a particular embodiment, the network node comprises a core network node, and the method further comprises receiving interference information from at least one base station, the priority radar signal detected based on the interference information.

In a particular embodiment, the priority radar signal is associated with a higher priority service than a service that is part of the terrestrial network.

In a particular embodiment, the priority radar signal comprises an airborne radar signal.

In a particular embodiment, detecting the priority radar signal comprises sampling at least a portion of the spectrum.

In a particular embodiment, detecting the priority radar signal comprises performing at least one measurement in at least one time period or across at least a portion of a bandwidth of the spectrum to determine presence of the priority radar signal within the spectrum. In a further particular embodiment, the at least one time period comprises at least one slot.

In a particular embodiment, detecting the priority radar signal comprises selecting a plurality of sets of neighboring cells within the terrestrial network and performing the at least one measurement within each cell of set of the neighboring cells.

In a particular embodiment, each chosen set of neighboring cells are specific sectors of deployed cell sites, and the specific sectors are oriented in approximately a same azimuth relative to a reference compass direction.

In a particular embodiment, the priority radar signal is detected during a measurement slot, and the measurement slot comprising a slot wherein no devices are scheduled to transmit.

In a particular embodiment, the priority radar signal is detected while the network node is simultaneously transmitting at least one signal.

In a particular embodiment, detecting the priority radar signal comprises: receiving an uplink transmission from at least one wireless device; and determining that the uplink transmission varies from an average or expected uplink transmission.

In a particular embodiment, detecting the priority radar signal comprises: receiving an uplink transmission from at least one wireless device; and comparing a block error rate associated with an uplink transmission to an expected block error rate to determine a presence of the priority radar signal within the spectrum.

In a particular embodiment, detecting the priority radar signal comprises: storing a radar signature; and comparing and/or correlating the priority radar signal to the radar signature to determine a presence of the priority radar signal within the spectrum.

In a further particular embodiment, the radar signature identifies at least one of an expected bandwidth occupancy and time occupancy of the spectrum by the priority radar signal.

In a further particular embodiment, performing a plurality of measurements associated with the priority radar signal, and wherein the comparison and/or correlation of the priority radar signal to the radar signature is based on the plurality of measurements.

In a further particular embodiment, each of the plurality of measurements is associated with a particular one of a plurality of time windows and/or bandwidth windows.

In a particular embodiment, each of the plurality of measurements are associated with a unique one of a plurality of time shifts and/or frequency shifts.

In a particular embodiment, detecting the priority radar signal comprises: determining at least one of a bandwidth and time duration associated with the priority radar signal; and detecting the priority of the signal based on at least one of the bandwidth and the time duration.

In a particular embodiment, detecting the priority radar signal comprises computing an energy level associated with the priority radar signal within the spectrum.

In a particular embodiment, detecting the priority radar signal comprises: receiving information from at least one wireless device; and determining that the priority radar signal is within the spectrum based on the information from the at least one wireless device.

In a particular embodiment, the information comprises an interference report indicating a level of interference measured by the at least one wireless device.

In a further particular embodiment, the information comprises at least one RSRP measurement or RSRQ measurement.

In a particular embodiment, the network node assesses an impact of an interference caused by the priority radar signal on one or more devices of the terrestrial network. In a further particular embodiment, the terrestrial network comprises a plurality of cells, and wherein assessing the impact of the interference comprises determining at least one cell of the plurality of cells that are affected by the interference caused by the priority radar signal. In a further particular embodiment, performing the at least one action to protect priority radar signal within the spectrum comprises transmitting a message to at least one device associated with the at least one cell of the plurality of cells that are affected by the interference caused by the priority radar signal, and the message indicates the detection of the priority radar signal and triggers the at least one device to abstain from transmitting in the spectrum.

In a particular embodiment, the at least one device comprises a wireless device.

In a particular embodiment, the network node determines a portion of a frequency band that is affected by the priority radar signal, and performing the at least one action to protect the priority radar signal within the spectrum comprises abstaining from transmitting in the portion of the frequency band.

In a particular embodiment, performing the at least one action to protect the priority radar signal within the spectrum comprises transmitting, to at least one other device communicating with the network node, a message triggering the at least one other device to abstain from transmitting in the spectrum. In a further particular embodiment, the at least one other device comprises a wireless device.

In a particular embodiment, the network node comprises a base station.

In a particular embodiment, the network node comprises a core network node.

In a particular embodiment, the network node receives interference information from at least one base station, and the priority radar signal is detected based on the interference information.

In a particular embodiment, taking the at least one action comprises transmitting a signal, to at least one base station, and the signal indicates a presence of the priority radar signal within the spectrum and triggers the at least one base station to abstain from transmitting in the spectrum.

In a particular embodiment, taking the at least one action comprises transmitting a signal, to at least one wireless device, and the signal indicates a presence of the priority radar signal within the spectrum and triggers the at least one wireless device to abstain from transmitting in the spectrum.

FIG. 10 depicts a method 1200 by a wireless device 110 in a terrestrial network, according to certain embodiments. At step 1202, the wireless device 110 detects, within a spectrum associated with the terrestrial network, at least one priority radar signal that is not a part of the terrestrial network. Based on detecting the at least one priority radar signal, the wireless device 110 performs at least one action to mitigate a mutual impact of the terrestrial network and the at least one priority radar signal, at step 1204.

In a particular embodiment, the at least one priority radar signal is associated with a higher priority service than a service that is part of the terrestrial network.

In a particular embodiment, the at least one priority radar signal comprises an airborne radar signal.

In a particular embodiment, detecting the at least one priority radar signal comprises sampling at least a portion of the spectrum.

In a particular embodiment, the wireless device comprises a plurality of antennas, and each of the plurality of antennas detect a respective one of the plurality of priority radar signals.

In a particular embodiment, detecting the priority radar signal comprises performing at least one measurement in at least one time period or across at least a portion of a bandwidth of the spectrum to determine a presence of the at least one priority radar signal within the spectrum. In a further particular embodiment, the at least one time period comprises at least one slot.

In a particular embodiment, the at least one priority radar signal is detected during a measurement slot, and the measurement slot comprising a slot wherein no devices are scheduled to transmit.

In a particular embodiment, the at least one priority radar signal is detected while the wireless device is simultaneously transmitting at least one signal.

In a particular embodiment, detecting the at least one priority radar signal comprises: receiving a downlink transmission from at least one network node; and determining that the downlink transmission varies from an average or expected downlink transmission.

In a particular embodiment, detecting the at least one priority radar signal comprises: receiving a signal from at least one network node; performing interference cancellation on the signal to construct a residual signal from the signal received from the at least one network node; and determining a presence of the at least one priority radar signal based on the interference cancellation performed on the signal from the at least one network node.

In a particular embodiment, detecting the at least one priority radar signal comprises: receiving a downlink transmission from at least one network node; and comparing a block error rate associated with the downlink transmission to an expected block error rate to determine a presence of the at least one priority radar signal within the spectrum.

In a particular embodiment, detecting the at least one priority radar signal comprises: storing a radar signature; and comparing and/or correlating the at least one priority radar signal to the radar signature to determine a presence of the at least one priority radar signal within the spectrum. In a further particular embodiment, the radar signature identifies at least one of an expected bandwidth occupancy and time occupancy of the spectrum by the at least one priority radar signal.

In a particular embodiment, the wireless device performs a plurality of measurements associated with the at least one priority radar signal, and the comparison and/or correlation of the at least one priority radar signal to the radar signature is based on the plurality of measurements. In a further particular embodiment, each of the plurality of measurements is associated with a particular one of a plurality of time windows and/or bandwidth windows. In a further particular embodiment, each of the plurality of measurements are associated with a unique one of a plurality of time shifts and/or frequency shifts.

In a particular embodiment, detecting the at least one priority radar signal comprises computing an energy level associated with the at least one priority radar signal within the spectrum.

In a particular embodiment, taking the at least one action comprises transmitting, to a network node, information associated with the at least one priority radar signal. In a further particular embodiment, transmitting the information comprises transmitting an interference report indicating a level of interference measured by the at least one wireless device. In a further particular embodiment, the information comprises at least one RSRP measurement or RSRQ measurement.

In a particular embodiment, the wireless device determines a portion of a frequency band that is affected by the at least one priority radar signal, and performing the at least one action to protect the at least one priority radar signal within the spectrum comprises abstaining from transmitting in the portion of the frequency band.

In a particular embodiment, performing the at least one action to protect the at least one priority radar signal within the spectrum comprises transmitting, to a network node, a message triggering the network node to abstain from transmitting in the spectrum.

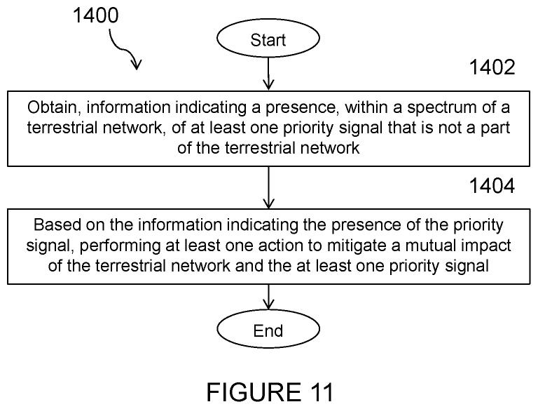

FIG. 11 depicts another method 1400 by a wireless device 110 in a terrestrial network, according to certain embodiments. At step 1402, the wireless device 110 obtains information indicating a presence, within a spectrum associated with the terrestrial network, of at least one priority radar signal that is not a part of the terrestrial network. Based on the information indicating the presence of the at least one priority radar signal, the wireless device 110 performs at least one action to mitigate a mutual impact of the terrestrial network and the at least one priority radar signal, at step 1404.

In a particular embodiment, when obtaining the information indicating the presence of the priority radar signal, the wireless device 110 performs at least one measurement in at least one time period or across at least a portion of a bandwidth of the spectrum to determine a presence of the at least one priority radar signal within the spectrum.

In a particular embodiment, when obtaining the information indicating the presence of the priority radar signal, the wireless device 110 receives the information from at least one other wireless device 110 and/or a network node 160.

In a particular embodiment, the at least one priority radar signal is detected during a time period when no devices are scheduled to transmit.

In a particular embodiment, the at least one priority radar signal is detected while the wireless device is simultaneously transmitting at least one signal.

In a particular embodiment, when obtaining the information indicating the presence of the at least one priority radar signal, the wireless device 110 receives a downlink transmission from at least one network node 160 and determines that the downlink transmission varies from an average or expected downlink transmission.

In a particular embodiment, when obtaining the information indicating the presence of the at least one priority radar signal, the wireless device 110 receives a signal from at least one network node 160 and performs interference cancellation on the signal to construct a residual signal from the signal received from the at least one network node 160. The wireless device 110 determines the presence of the at least one priority radar signal based on the interference cancellation performed on the signal from the at least one network node 160.

In a particular embodiment, when obtaining the information indicating the presence of the at least one priority radar signal, the wireless device 110 receives a downlink transmission from at least one network node 160 and compares a block error rate associated with the downlink transmission to an expected block error rate to determine the presence of the at least one priority radar signal within the spectrum.

In a particular embodiment, when obtaining the information indicating the presence of the at least one priority radar signal, the wireless device 110 stores a radar signature identifying at least one of an expected bandwidth occupancy and time occupancy of the spectrum by the at least one priority radar signal and compares and/or correlates the at least one priority radar signal to the radar signature to determine a presence of the at least one priority radar signal within the spectrum.

In a particular embodiment, when obtaining the information indicating the presence of the at least one priority radar signal, the wireless device 110 computes an energy level associated with the at least one priority radar signal within the spectrum.

In a particular embodiment, when taking the at least one action, the wireless device 110 transmits, to a network node 160, information associated with the at least one priority radar signal.

In a particular embodiment, the information transmitted to the network node 160 comprises at least one of: an interference report indicating a level of interference measured by the at least one wireless device 110; at least one RSRP measurement; and at least one RSRQ measurement.

In a particular embodiment, the wireless device 110 receives, from a network node 160, a message indicating that the wireless device 110 is to abstain from transmitting in the spectrum.

In a particular embodiment, the wireless device 110 determines a portion of a frequency band that is affected by the at least one priority radar signal and abstains from transmitting in the portion of the frequency band.

In a particular embodiment, when performing the at least one action, the wireless device 110 transmits, to a network node 160, a message triggering the network node to abstain from transmitting in the spectrum.

### ADDITIONAL EXAMPLE EMBODIMENTS

Example Embodiment 1. A computer program comprising instructions which when executed on a computer perform any of the methods described above.
Example Embodiment 2. A computer program product comprising computer program, the computer program comprising instructions which when executed on a computer perform any of the methods described above with regard to FIG. 9.
Example Embodiment 3. A non-transitory computer readable medium storing instructions which when executed by a computer perform any of the methods described above.
Example Embodiment 4. A network node comprising processing circuitry configured to perform any of the methods described above.
Example Embodiment 5. A computer program comprising instructions which when executed on a computer perform any of the methods described above.
Example Embodiment 6. A computer program product comprising computer program, the computer program comprising instructions which when executed on a computer perform any of the methods described above.
Example Embodiment 7. A non-transitory computer readable medium storing instructions which when executed by a computer perform any of the methods described above.
Example Embodiment 8. A network node comprising processing circuitry configured to perform any of the methods described above.
Example Embodiment 9. A wireless device comprising: processing circuitry configured to perform any of the steps described above; and power supply circuitry configured to supply power to the wireless device.
Example Embodiment 10. A network node comprising: processing circuitry configured to perform any of the steps described above; power supply circuitry configured to supply power to the wireless device.
Example Embodiment 11. A wireless device, the wireless device comprising: an antenna configured to send and receive wireless signals; radio front-end circuitry connected to the antenna and to processing circuitry, and configured to condition signals communicated between the antenna and the processing circuitry; the processing circuitry being configured to perform any of the steps described above; an input interface connected to the processing circuitry and configured to allow input of information into the wireless device to be processed by the processing circuitry; an output interface connected to the processing circuitry and configured to output information from the wireless device that has been processed by the processing circuitry; and a battery connected to the processing circuitry and configured to supply power to the wireless device.
Example Embodiment 12. The method of any of the previous embodiments, wherein the network node comprises a base station.
Example Embodiment 13. The method of any of the previous embodiments, wherein the wireless device comprises a user equipment (UE).

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure.

1. A method performed by a network node in a terrestrial network, the method comprising:
detecting, within a spectrum associated with the terrestrial network, a priority radar signal that is not a part of the terrestrial network; and
based on detecting the priority radar signal, performing at least one action to mitigate a mutual impact of the terrestrial network and the priority radar signal on each other.

2. The method of claim 1, wherein detecting the priority radar signal that is not a part of the terrestrial network comprises at least one of:
receiving, from a wireless device, information indicating a presence of the priority radar signal; and
receiving, from another network node, information indicating the presence of the priority radar signal.

3. The method of claim 1, wherein the information comprises at least one of: a level of interference; at least one Reference Signal Received Power, RSRP, measurement; and at least one Reference Signal Received Quality, RSRQ, measurement

4. The method of claim 1, wherein detecting the priority radar signal that is not a part of the terrestrial network comprises at least one of:
determining that an uplink transmission from at least one wireless device varies from an average or expected uplink transmission; and
determining that a block error rate associated with an uplink transmission from at least one wireless device varies from an expected block error rate.

5. The method of claim 1, wherein detecting the priority radar signal that is not part of the terrestrial network comprises:
comparing and/or correlating the priority radar signal to a radar signature identifying at least one of an expected bandwidth occupancy and time occupancy of the spectrum by the priority radar signal.

6. The method of claim 1, wherein performing the at least one action comprises at least one of:
vacating the spectrum by the network node;
transmitting, to at least one other network node, a signal to trigger the at least one other network node to abstain from transmitting in the spectrum; and
transmitting, to at least one wireless device, a signal to trigger the at least one wireless device to abstain from transmitting in the spectrum.

7. The method of claim 1, wherein detecting the priority radar signal comprises performing at least one measurement in at least one time period or across at least a portion of a bandwidth of the spectrum to determine a presence of the priority radar signal within the spectrum.

8. The method of claim 7, wherein detecting the priority radar signal comprises:
selecting at least one or at least a portion of a neighboring cell within the terrestrial network, and
performing the at least one measurement with respect to the at least one neighboring cell or the portion of the neighboring cell.

9. The method of claim 8, wherein the at least one neighboring cell comprises a plurality of sets of neighboring cells, each set of neighboring cells being associated with a specific sector of a deployed cell site, wherein each specific sector is oriented in approximately a same azimuth relative to a reference compass direction.

10. The method of claim 7, wherein no devices are scheduled to transmit during the at least one time period.

11. The method of claim 1, wherein the network node is capable of full duplex and the priority radar signal is detected while the network node is simultaneously transmitting at least one signal.

12. The method of claim 1, wherein detecting the priority radar signal comprises computing an energy level associated with the priority radar signal within the spectrum.

13. The method of claim 1, wherein the network node comprises a base station.

14. The method of claim 1, wherein the network node comprises a core network node and the method further comprises receiving interference information from at least one base station, the priority radar signal detected based on the interference information.

15. A method performed by a wireless device in a terrestrial network, the method comprising:
obtaining information indicating a presence within a spectrum associated with the terrestrial network of at least one priority radar signal that is not a part of the terrestrial network; and
based on the information indicating the presence of the at least one priority radar signal, performing at least one action to mitigate a mutual impact of the terrestrial network and the at least one priority radar signal.

16. The method of claim 15, wherein obtaining the information indicating the presence of the priority radar signal comprises performing at least one measurement in at least one time period or across at least a portion of a bandwidth of the spectrum to determine a presence of the at least one priority radar signal within the spectrum.

17. The method of claim 15, wherein obtaining the information indicating the presence of the priority radar signal comprises receiving the information from at least one other wireless device and/or a network node.

18. (canceled)

19. (canceled)

20. The method of claim 15, wherein obtaining the information indicating the presence of the at least one priority radar signal comprises:
receiving a downlink transmission from at least one network node; and
determining that the downlink transmission varies from an average or expected downlink transmission.

21. The method of claim 15, wherein obtaining the information indicating the presence of the at least one priority radar signal comprises:
receiving a signal from at least one network node;
performing interference cancellation on the signal to construct a residual signal from the signal received from the at least one network node; and
determining the presence of the at least one priority radar signal based on the interference cancellation performed on the signal from the at least one network node.

22. The method of claim 15, wherein obtaining the information indicating the presence of the at least one priority radar signal comprises:
receiving a downlink transmission from at least one network node; and
comparing a block error rate associated with the downlink transmission to an expected block error rate to determine the presence of the at least one priority radar signal within the spectrum.

23.-31. (canceled)
